(19) United States
(12) Patent Application Publication
(10) Pub. No.: US 2022/0279545 A1
(43) Pub. Date: Sep. 1, 2022

(54) TERMINAL AND COMMUNICATION METHOD

(71) Applicant: NTT DOCOMO, INC., Tokyo (JP)

(72) Inventors: Shohei Yoshioka, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 17/637,403

(22) PCT Filed: Aug. 21, 2020
(86) PCT No.: PCT/JP2020/031731

§ 371 Date: Feb. 22, 2022

(30) Foreign Application Priority Data
Aug. 28, 2019 (JP) 2019-155835

(51) Int. Cl. H04W 72/12; H04W 72/04; H04L 1/18; H04L 5/00; H04L 1/08

(52) U.S. Cl. CPC H04W 72/1263; H04W 72/0446; H04L 1/1812; H04L 5/0053; H04L 1/08

(57) ABSTRACT

A terminal includes a receiving unit that receives information for scheduling a first resource used for inter-terminal direct communication, information for scheduling a second resource used for a communication with a base station, and data through the second resource, from the base station; and a transmitting unit that transmits data to another terminal using the first resource, wherein the receiving unit receives a first response related to retransmission control corresponding to the transmitted data from the another terminal, wherein the terminal further includes a control unit that determines a third response related to retransmission control based on the first response and a second response related to retransmission control corresponding to the data through the second resource, and wherein the transmitting unit transmits the third response to the base station.

### TECHNICAL FIELD

The present invention relates to a terminal and a communication method in a radio communication system.

### BACKGROUND ART

In Long Term Evolution (LTE) and LTE successor systems (e.g., LTE Advanced (LTE-A), New Radio (NR) (which is also referred to as 5G)), a Device to Device (D2D) technology has been studied in which terminals communicate directly with each other without a base station (e.g., Non-Patent Document 1).

The D2D reduces traffic between a terminal and a base station and enables communication between terminals even if a base station is unable to communicate in an event of a disaster, or the like. Although 3rd Generation Partnership Project (3GPP) refers to D2D as a “sidelink,” D2D, which is more generic term, is used in this specification. However, in the descriptions of embodiments described below, a sidelink is also used, if necessary.

D2D communication is broadly classified into D2D discovery (which is also referred to as D2D discovery) for discovering another terminal capable of communicating and D2D communication (which is also referred to as D2D direct communication, D2D communication, inter-terminal direct communication, or the like) for directly communicating between terminals. In the following, when D2D communication, D2D discovery, or the like are not specifically distinguished, it is simply called D2D. Signal sent and received by D2D are called D2D signals. Various use cases of Vehicle to Everything (V2X) services in NR have been studied (e.g., Non-Patent Document 2).

### RELATED ART DOCUMENT

### Non-Patent Document

Non-Patent Document 1: 3GPP TS 36.211 V15.6.0(2019-06)

Non-Patent Document 2: 3GPP TR 22.886 V15.1.0(2017-03)

### SUMMARY OF THE INVENTION

### Problem to be Solved by the Invention

For inter-terminal direct communication in NR-V2X, it has been studied to support Hybrid automatic repeat request (HARQ) control. However, a method, which is for transmitting information on an inter-terminal direct communication HARQ response and a downlink HARQ response from a terminal that performs transmission in the inter-terminal direct communication to a base station, has been unclear.

The present invention has been made in view of the above-described point, and an object is to appropriately execute retransmission control in inter-terminal direct communication.

### Means for Solving the Problem

According to the disclosed technology, there is provided a terminal including a receiving unit that receives, from a base station, information for scheduling a first resource used for inter-terminal direct communication, information for scheduling a second resource used for a communication with the base station, and data through the second resource; and a transmitting unit that transmits data to another terminal using the first resource, wherein the receiving unit receives a first response related to retransmission control corresponding to the transmitted data from the another terminal, wherein the terminal further includes a control unit that determines a third response related to retransmission control based on the first response and a second response related to retransmission control corresponding to the data through the second resource, and wherein the transmitting unit transmits the third response to the base station.

### Advantage of the Invention

According to the disclosed technology, retransmission control can be appropriately executed in inter-terminal direct communication.

### BRIEF DESCRIPTION OF DRAWINGS

FIG. 1 is a diagram illustrating V2X.

FIG. 2 is a diagram illustrating an example (1) of a transmission mode of V2X

FIG. 3 is a diagram illustrating an example (2) of a transmission mode of V2X

FIG. 4 is a diagram illustrating an example (3) of a transmission mode of V2X

FIG. 5 is a diagram illustrating an example (4) of a transmission mode of V2X

FIG. 6 is a diagram illustrating an example (5) of a transmission mode of V2X

FIG. 7 is a diagram illustrating an example (1) of a communication type of V2X;

FIG. 8 is a diagram illustrating an example (2) of a communication type of V2X;

FIG. 9 is a diagram illustrating an example (3) of a communication type of V2X;

FIG. 10 is a diagram illustrating a configuration and an operation (1) of a radio communication system according to an embodiment of the present invention;

FIG. 11 is a diagram illustrating an example of HARQ-ACK Code Book transmission.

FIG. 12 is a diagram illustrating an example of order of HARQ-ACK.

FIG. 13 is a diagram illustrating a DAI.

FIG. 14 is a diagram illustrating a configuration and operation (2) of a radio communication system according to an embodiment of the present invention.

FIG. 15 is a diagram illustrating an example of a functional configuration of a base station 10 according to an embodiment of the present invention.

FIG. 16 is a diagram illustrating an example of a functional configuration of a terminal 20 according to an embodiment of the present invention.

FIG. 17 is a diagram illustrating an example of a hardware configuration of the base station 10 or the terminal 20 according to an embodiment of the present invention.

### EMBODIMENTS OF THE INVENTION

In the following, embodiments of the present invention are described with reference to the drawings. The embodiments described below are examples, and embodiments to which the present invention is applied are not limited to the following embodiments.

In operating a radio communication system according to an embodiment of the present invention, existing techniques are used as appropriate. Here, the existing technology is, for example, existing LTE, but is not limited to the existing LTE. The term “LTE” as used this specification has a broad meaning including LTE-Advanced and a method after LTE-Advanced (e.g., NR) or Wireless Local Area Network (LAN), unless otherwise specified.

In the embodiments of the present invention, a duplex method may be a Time Division Duplex (TDD) method, a Frequency Division Duplex (FDD) method, or any other method (e.g., Flexible Duplex).

Furthermore, in the embodiments of the present invention, configuring a radio parameter or the like may imply that a predetermined value is preconfigured or a radio parameter transmitted from a base station 10 or a terminal 20 is configured.

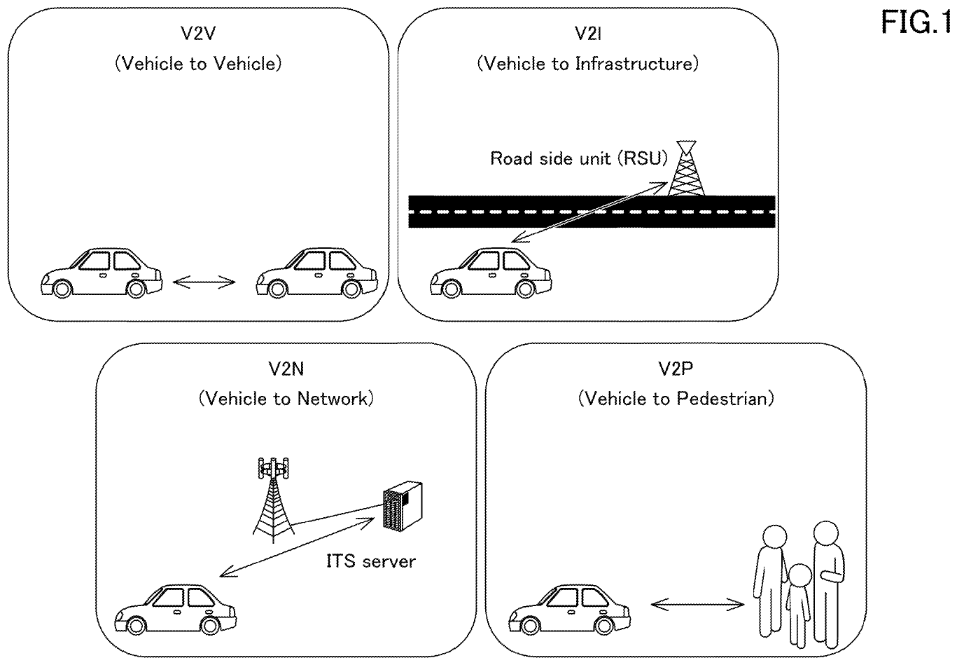

FIG. 1 is a diagram illustrating V2X. In the 3GPP, it has been studied to implement Vehicle to Everything (V2X) or enhanced V2X (eV2X) by extending a D2D function, and specifications have been developed. As illustrated in FIG. 1, V2X is a part of Intelligent Transport Systems (ITS), and V2X is a collective term for Vehicle to Vehicle (V2V), which means a mode of communication between vehicles; Vehicle to Infrastructure (V2I), which means a mode of communication between a vehicle and a roadside unit (Road-Side Unit); Vehicle to Network (V2N), which means a mode of communication between a vehicle and an ITS server; and Vehicle to Pedestrian (V2P), which means a mode of communication between a vehicle and a mobile terminal held by a pedestrian.

In addition, V2X using LTE or NR cellular communication and inter-terminal communication has been studied in 3GPP. V2X using cellular communication is also called cellular V2X. For NR V2X, it has been studied to achieve large capacity, low latency, high reliability, and Quality of Service (QoS) control.

It is expected that, for LTE V2X or NR V2X, studies not limited to the 3GPP specifications will be progressed. For example, it is expected that securing interoperability, cost efficiency with implementation of a higher layer, a method of combining, or switching between, a plurality of Radio Access Technologies (RATs), addressing a regulation in each country, methods of data acquisition, delivery, database management, and utilization of a V2X platform of LTE or NR, and the like will be studied.

In the embodiments of the present invention, it is primarily assumed that a communication device is installed in a vehicle, but the embodiments of the present invention are not limited to such embodiments. For example, the communication device may be a terminal held by a person, or the communication device may be a drone or a device installed in an airplane, or the communication device may be a base station, an RSU, a relay station (relay node), a terminal having scheduling capability, or the like.

Note that Sidelink (SL) may be distinguished from Uplink (UL) or Downlink (DL) based on any of the following 1)-4) or a combination thereof. Furthermore, SL may have another name.
1) Resource allocation in a time domain;
2) Resource allocation in a frequency domain;
3) Synchronization signal (including Sidelink Synchronization Signal (SLSS)) to be referred to; and
4) Reference signal used for pass-loss measurement for transmission power control.

Furthermore, for SL or UL Orthogonal Frequency Division Multiplexing (OFDM), either Cyclic-Prefix OFDM (CP-OFDM), Discrete Fourier Transform-Spread-OFDM (DFT-S-OFDM), OFDM without Transform precoding or OFDM with Transform precoding may be applied.

In LTE SL, Mode3 and Mode4 are specified for allocating SL resources to the terminal 20. In Mode3, transmission resources are dynamically allocated by the Downlink Control Information (DCI) transmitted from the base station 10 to the terminal 20. In Mode3, Semi Persistent Scheduling (SPS) is also possible. In Mode4, the terminal 20 autonomously selects a transmit resource from a resource pool.

A slot in the embodiments of the present invention may be interpreted as a symbol, a mini-slot, a subframe, a radio frame, and a Transmission Time Interval (TTI). A cell in the embodiments of the present invention may be interpreted as a cell group, a carrier component, a BWP, a resource pool, a resource, a Radio Access Technology (RAT), a system (including a wireless LAN), and the like.

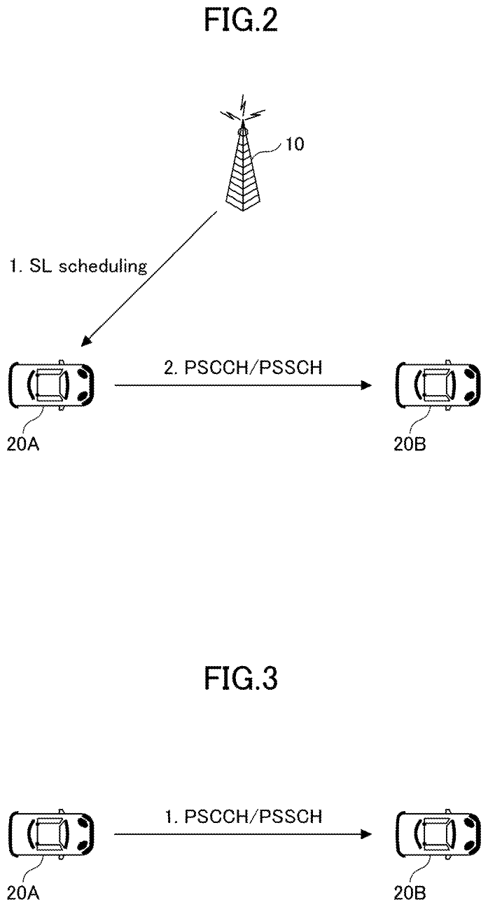

FIG. 2 is a diagram for illustrating an example (1) of a transmission mode of V2X. In the side-link communication transmission mode illustrated in FIG. 2, at step 1, the base station 10 transmits the sidelink scheduling to the terminal 20A. Subsequently, the terminal 20A transmits Physical Sidelink Control Channel (PSCCH) and Physical Sidelink Shared Channel (PSSCH) to the terminal 20B based on the received scheduling (Step 2). The transmission mode of the side-link communication illustrated in FIG. 2 may be referred to as the sidelink transmission mode 3 in the LTE. In the side link transmission mode 3 in the LTE, Uu-based side link scheduling is performed. Uu is a radio interface between Universal Terrestrial Radio Access Network (UTRAN) and User Equipment (UE). The transmission mode of the sidelink communication illustrated in FIG. 2 may be referred to as the sidelink transmission mode 1 in the NR.

FIG. 3 is a diagram for illustrating an example (2) of a transmission mode of V2X. In the sidelink communication transmission mode illustrated in FIG. 3, in step 1, the terminal 20A transmits PSCCH and PSSCH to the terminal 20B using an autonomously selected resource. The transmission mode of the sidelink communication illustrated in FIG. 3 may be referred to as the sidelink transmission mode 4 in LTE. In the side link transmission mode 4 in the LTE, the UE itself performs resource selection.

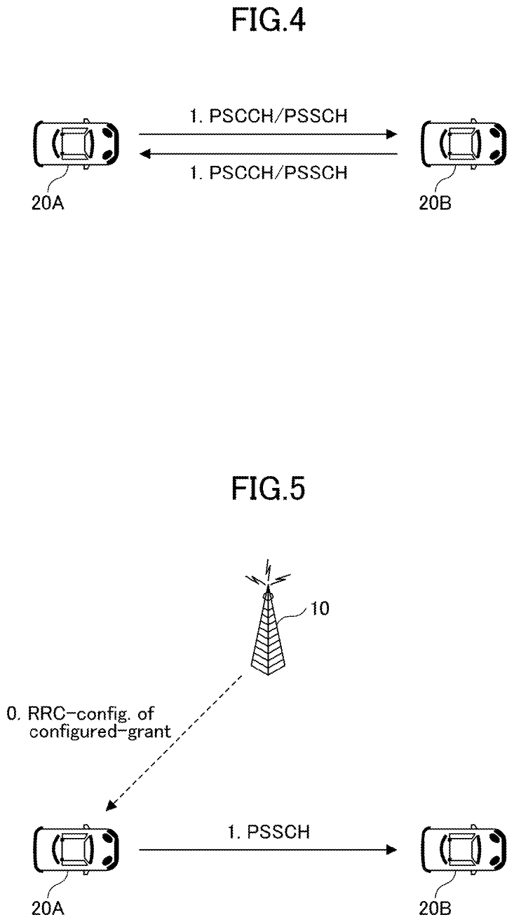

FIG. 4 is a diagram illustrating an example (3) of a transmission mode of V2X. In the sidelink communication transmission mode illustrated in FIG. 4, in step 1, the terminal 20A transmits PSCCH and PSSCH to the terminal 20B using autonomously selected resources. Similarly, the terminal 20B transmits PSCCH and PSSCCH to terminal 20A using autonomously selected resources (step 1). The transmission mode of the sidelink communication illustrated in FIG. 4 may be referred to as the sidelink transmission mode 2a in the NR. In the sidelink transmission mode 2 in the NR, the terminal 20 itself performs resource selection.

FIG. 5 is a diagram illustrating an example (4) of a transmission mode of V2X. In the sidelink communication transmission mode illustrated in FIG. 5, in step 0, the base station 10 transmits a sidelink grant to the terminal 20A via a Radio Resource Control (RRC) configuration. Subsequently, in Step 1, the terminal 20A transmits the PSSCH to the terminal 20B based on the received resource pattern. The transmission mode of the sidelink communication illustrated in FIG. 5 may be referred to as the sidelink transmission mode 2c in the NR.

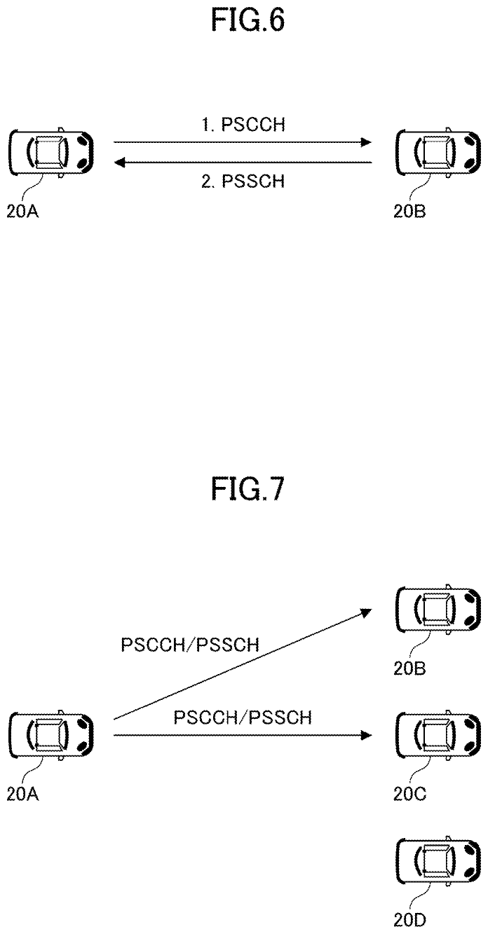

FIG. 6 is a diagram illustrating an example (5) of a transmission mode of V2X. FIG. 6 is a diagram illustrating an example (5) of a transmission mode of V2X. In the sidelink communication transmission mode illustrated in FIG. 6, in step 1, the terminal 20A transmits sidelink scheduling to the terminal 20B via the PSCCH. Subsequently, in step 2, the terminal 20B transmits the PSSCH to the terminal 20A based on the received scheduling. The transmission mode of the sidelink communication illustrated in FIG. 6 may be referred to as the sidelink transmission mode 2d in the NR.

FIG. 7 is a diagram illustrating an example (1) of a communication type of V2X. The sidelink communication type illustrated in FIG. 7 is unicast. The terminal 20A transmits PSCCH and PSSCH to terminal 20. In the example illustrated in FIG. 7, the terminal 20A performs unicast to the terminal 20B and performs unicast to the terminal 20C.

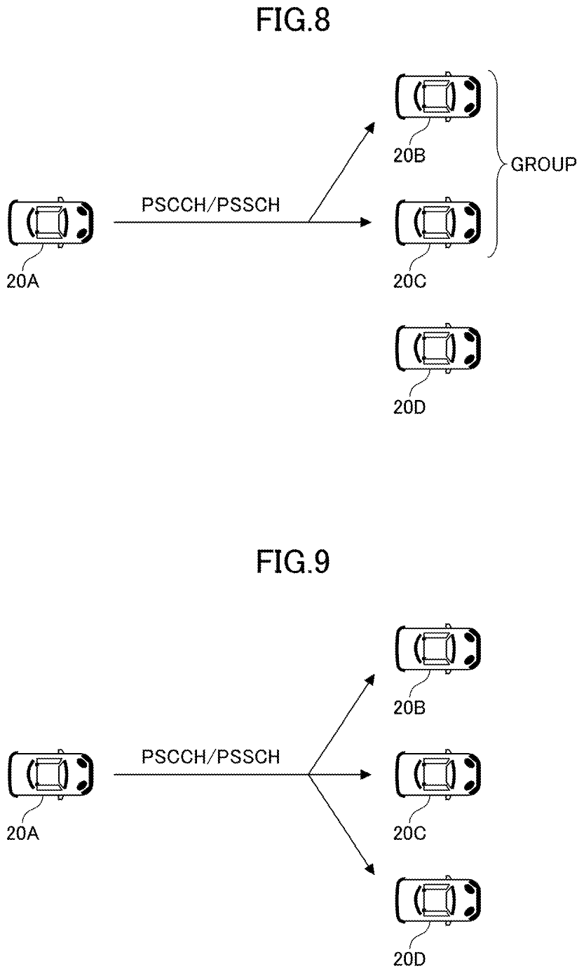

FIG. 8 is a diagram illustrating an example (2) of a communication type of V2X. The sidelink communication type illustrated in FIG. 8 is groupcast. The terminal 20A transmits PSCCH and PSSCH to a group to which one or more terminals 20 belong. In the example illustrated in FIG. 8, the group includes the terminal 20B and the terminal 20C, and the terminal 20A performs groupcast to the group.

FIG. 9 is a diagram illustrating an example (3) of a communication type of V2X. The sidelink communication type illustrated in FIG. 9 is broadcast. The terminal 20A transmits PSCCH and PSSCH to one or more terminals 20. In the example illustrated in FIG. 9, the terminal 20A broadcasts to the terminal 20B, the terminal 20C, and terminal 20D. The terminal 20A illustrated in FIG. 7 to FIG. 9 may be referred to as a header UE.

Furthermore, it is assumed that HARQ is supported for sidelink unicast and sidelink groupcast in NR-V2X. In addition, Sidelink Feedback Control Information (SFCI) including a HARQ response is defined in NR-V2X. In addition, SFCI transmission via a Physical Sidelink Feedback Channel (PSFCH) has been studied.

In the following descriptions, it is assumed that PSFCH is used in the transmission of HARQ-ACK on the sidelink. This is an example. For example, PSCCH may be used to transmit HARQ-ACK on the sidelink, PSSCH may be used to transmit HARQ-ACK on the sidelink, or another may be used to transmit HARQ-ACK on the sidelink.

As described above, it is assumed that HARQ operation is supported in NR-V2X. However, no specific proposal has been made on how to transmit multiple HARQ-ACKs corresponding to SL data and DL data in the configuration assumed in NR-V2X. No specific suggestions have been made for the configuration of a HARQ codebook for SL and DL data. In addition, no specific proposals have been made for a payload size for sending HARQ-ACKs corresponding to SL data and DL data. Accordingly, a problem with the related art is that multiple HARQ-ACK reports cannot be properly implemented.

In the following, for convenience, the overall information reported by the terminal 20 in the HARQ is referred to as HARQ-ACK. This HARQ-ACK may also be referred to as HARQ-ACK information. More specifically, the code book applied to the information on the HARQ-ACK reported from the terminal 20 to the base station 10 or the like is called the HARQ-ACK code book. The HARQ-ACK code book defines the bit sequence of HARQ-ACK information. Note that ACK is transmitted by “HARQ-ACK,” and NACK is also transmitted by “HARQ-ACK.”

### First Embodiment

In a first embodiment, in the sidelink transmission mode 1 illustrated in FIG. 2, the terminal 20B that received the SL data on PSSCH transmits the HARQ-ACK through PSFCH to the terminal 20A that transmits the data. The terminal 20A transmits HARQ-ACK including the HARQ-ACK to the base station 10.

<Configuration Example of the First Embodiment>

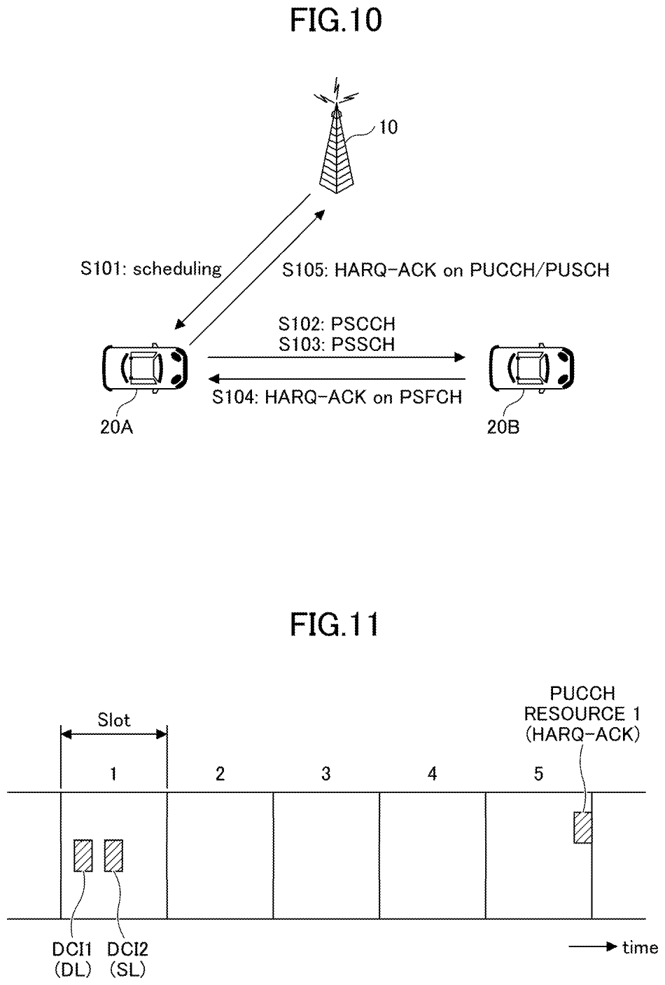

FIG. 10 is a diagram illustrating a configuration (and an operation) of a radio communication system according to the first embodiment. The configuration may be the same in Example 2.

As illustrated in FIG. 10, the radio communication system according to the first embodiment includes the base station 10, the terminal 20A, and the terminal 20B. Note that, actually, there are a large number of user devices, but FIG. 10 illustrates the terminal 20A and the terminal 20B, as an example.

In the following, when the terminals 20A, 20B, or the like are not particularly distinguished, the terminals are simply denoted as “terminal 20” or “user equipment.” FIG. 10 illustrates, for example, a case in which both the terminal 20A and the terminal 20B are within the coverage of the cell. However, the operation in the first embodiment can be applied to the case in which the terminal 20B is outside the coverage.

As described above, in the embodiment, the terminal 20 is, for example, a device installed in a vehicle, such as an automobile, and has a cellular communication function as a UE in an LTE or NR and a sidelink function. The terminal 20 may be a generic mobile terminal (such as a smartphone). The terminal 20 may also be an RSU. The RSU may be a UE-type RSU having the function of a UE or a gNB-type RSU having the function of a base station device.

The terminal 20 may be a device other than a single housing device. For example, even if various sensors are arranged to be distributed in a vehicle, the device including the various sensors is the terminal 20.

Details of the processing of sidelink transmission data by the terminal 20 are basically the same as details of the processing of UL transmission in LTE or NR. For example, the terminal 20 scrambles the codeword of transmitted data, modulates to generate complex-valued symbols, and maps the complex-valued symbols to one or two layers for precoding. The precoded complex-valued symbols are then mapped to resource elements to generate a transmission signal (e.g., complex-valued time-domain SC-FDMA signal) and transmit it from each antenna port.

The base station 10 is provided with a function of cellular communication as a base station in LTE or NR and a function of enabling communication of the terminal 20 according to the embodiment (e.g., resource pool configuration, resource allocation). The base station 10 may also be an RSU (gNB-type RSU).

In the radio communication system according to the first embodiment, a signal waveform used by the terminal 20 for SL or UL may be OFDMA, SC-FDMA, or another signal waveform.

<Operation Example of the First Embodiment>

An operation example of the radio communication system according to the first embodiment is described with reference to FIG. 10.

In S101, the base station 10 performs SL scheduling by sending Downlink Control Information (DCI) to the terminal 20A via PDCCH. In the following, for convenience, the DCI for SL scheduling is called SL scheduling DCI.

The first embodiment also assumes that, in S101, the base station 10 transmits a DCI for DL scheduling (which may be referred to as DL assignment) to the terminal 20A by the PDCCH. In the following, for convenience, the DCI for DL scheduling is referred to as the DL scheduling DCI. The terminal 20A that receives the DL scheduling DCI receives the DL data on the PDSCH using the resources specified in the DL scheduling DCI.

In S102 and S103, the terminal 20A transmits the Sidelink Control Information (SCI) on PSCCH using the resource specified in the SL scheduling DCI and transmits the SL data through PSSCH. Note that, in SL scheduling DCI, only PSSCH resources may be specified. In this case, for example, the terminal 20A may transmit the SCI (PSCCH) using frequency resources adjacent to the PSSCH frequency resources with the same time resources as the PSSCH time resources.

The terminal 20B receives the SCI (PSCCH) and the SL data (PSSCH) transmitted from the terminal 20A. The SCI received through PSCCH includes information on a PSFCH resource for the terminal 20B to send a HARQ-ACK for receipt of the data.

The information on the resource is included in the DL scheduling DCI or SL scheduling DCI transmitted from the base station 10 in S101, and the terminal 20A obtains the information on the resource from the DL scheduling DCI or the SL scheduling DCI and includes it in the SCI. Alternatively, the DCI transmitted from the base station 10 does not include the information on the resource, and the terminal 20A may autonomously include the information on the resource in the SCI and transmit the information on the resource.

In S104, the terminal 20B transmits the HARQ-ACK for the received data to the terminal 20A using the PSFCH resource specified in the received SCI.

In S105, the terminal 20A transmits the HARQ-ACK using the PUCCH resources specified by the DL scheduling DCI (or the SL scheduling DCI) at the timing (e.g., timing in units of slots) specified by the DL scheduling DCI (or the SL scheduling DCI), for example, and the base station 10 receives the HARQ-ACK. The HARQ-ACK codebook may include a HARQ-ACK received from the terminal 20B and a HARQ-ACK for DL data. However, HARQ-ACK for DL data is not included if DL data is not allocated.

<First Embodiment: Details of Processing of HARQ-ACK Codebook>

In the following, an example of a configuration method of the HARQ-ACK codebook, transmitted by the terminal 20A to the base station 10, is described in more detail.

<Construction>

If each of the DL scheduling DCI and the SL scheduling DCI received by the terminal 20A includes a value of a PDSCH/PDCCH-to-HARQ_feedback timing indicator field, and the value indicates the same slot in the DL scheduling DCI and SL scheduling DCI, the terminal 20A transmits HARQ-ACK for the DL data and HARQ-ACK for the SL data (HARQ-ACK received by the terminal 20A from the terminal 20B in S104) using the same PUCCH resource. That is, in this case, the terminal 20A includes the HARQ-ACK for the DL data and the HARQ-ACK for the SL data (the HARQ-ACK received by the terminal 20A in S104) in one HARQ-ACK code book and transmits the HARQ-ACK code book.

The above-described “PDSCH/PDCH-to-HARQ feedback timing indicator field” indicates “PDSCH-to-HARQ_feedback timing indicator field” or “PDCCH-to-HARQ_feedback timing indicator field.”

The “PDSCH-to-HARQ_feedback timing indicator field” is a field included in the DL scheduling DCI, and the value of the field indicates HARQ_feedback timing (e.g., number of slots) from PDSCH (DL data) reception.

The “PDCCH-to-HARQ_feedback timing indicator field” is a field included in the SL scheduling DCI, and the value of the field indicates HARQ_feedback timing (e.g., number of slots) from reception of the PDCCH (the SL scheduling DCI).

The above is an example and the DL scheduling DCI may include a “PDCH-to-HARQ_feedback timing indicator field” or the SL scheduling DCI may include a “PDSCH-to-HARQ_feedback timing indicator field.”

For example, the above-described processing may be expressed, in other words, as follows: “when the DL scheduling DCI received by the terminal 20A includes a value of the PDSCH-to-HARQ feedback timing indicator field and the SL scheduling DCI received by the terminal 20A includes a value of the PDCCH-to-HARQ_feedback timing indicator field, and when these values indicate the same slot as the HARQ_feedback timings, the terminal 20A transmits the HARQ-ACK for the DL data and the HARQ-ACK for the SL data (HARQ-ACK received by the terminal 20A in S104) using the same PUCCH resource.

FIG. 11 illustrates an example of DCI reception and HARQ-ACK transmission at the terminal 20A. In FIG. 11, DCI 1 represents DL scheduling DCI and DCI 2 represents SL scheduling DCI. In FIG. 11, for example, the terminal 20A receives the DCI 1 and the DCI 2 in the slot 1. If these DCIs indicate slot 5 as HARQ_feedback timing, the terminal 20A uses PUCCH resource 1 to transmit a HARQ-ACK codebook including HARQ-ACK for DL data and HARQ-ACK for SL data to base station 10.

<HARQ-ACK Order>

There are the following Options A, B, and C regarding the order of HARQ-ACK when the terminal 20 creates a HARQ-ACK codebook including HARQ-ACK for DL data and HARQ-ACK for SL data.

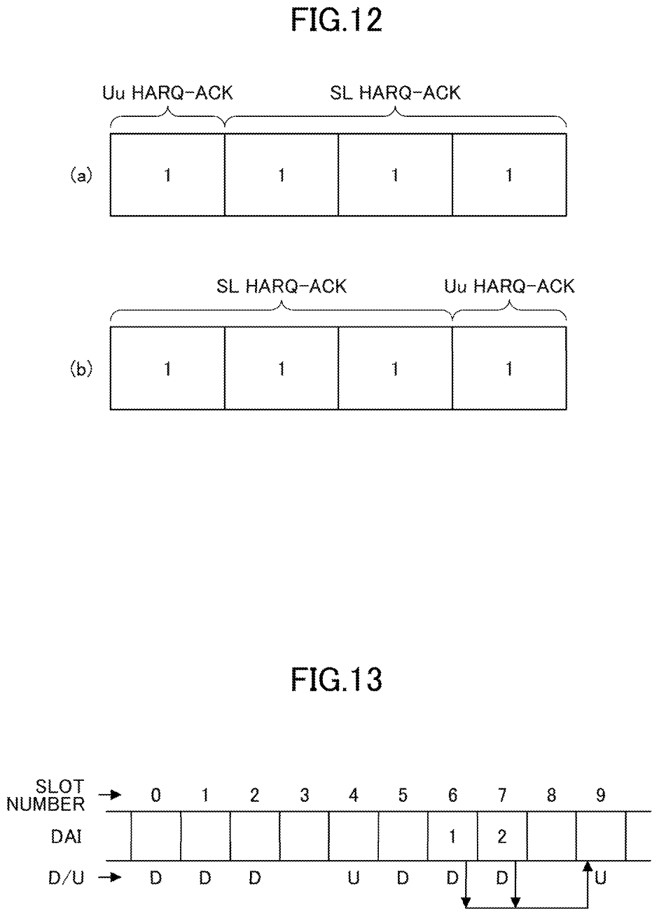

Option A) In Option A, for example, as illustrated in FIG. 12A, first, HARQ-ACK for the DL data (which is described as Uu HARQ-ACK in FIG. 12) is stored, and, subsequently, HARQ-ACK for the SL data (SL HARQ-ACK) is stored.

Option B) In Option B, for example, as illustrated in FIG. 12B, first, HARQ-ACK for the SL data is stored, and, subsequently, HARQ-ACK for DL data is stored.

The example of FIG. 12 illustrates the case in which the HARQ-ACK code book consists of 4-bit HARQ-ACK information bits, and the case in which all bits are 1 as an example. It is also assumed that the left end of the HARQ-ACK code book illustrated in FIG. 12 is the first in the order in which the bits of the HARQ-ACK code book are arranged, and the bits are arranged from the left end to the right. Note that this is an example.

In the example of FIG. 12, it is assumed that the terminal 20A transmits SL data (PSSCH) to a plurality of user devices and receives HARQ-ACK for SL data from the plurality of user devices.

When the terminal 20A receives HARQ-ACKs for SL data from a plurality of user devices and stores the HARQ-ACKs from each user device in each bit of the HARQ-ACK codebook, the order in which the HARQ-ACKs from the plurality of user devices is arranged in the HARQ-ACK codebook is determined, for example, based on the UE-ID of the plurality of user devices (e.g., descending order of IDs, or ascending order of IDs). Alternatively, if the terminal 20A receives the SL scheduling DCI for each of the plurality of user devices from the base station 10 for transmission of SL data to the plurality of user devices, the order in which the HARQ-ACKs from the plurality of user devices are arranged in the HARQ-ACK codebook may be determined in the temporal order in which the corresponding SL scheduling DCIs are received, or the order in which the HARQ-ACKs from the plurality of user devices are arranged in the HARQ-ACK codebook may be determined in the temporal order in which the SCIs are transmitted to the respective plurality of user devices.

Option C) In Option C, instead of having a predetermined method of determining the order as described above, the order is specified in the DL scheduling DCI or the SL scheduling DCI received by the terminal 20A, and the order is determined according to the specification.

<DAI>

The DL scheduling DCI (or SL scheduling DCI) includes Downlink assignment index (DAI). FIG. 13 is a diagram illustrating an example of DAI. FIG. 13 illustrates an example in which the terminal 20A is configured to transmit, in slot 9 (UL), HARQ-ACK for the DL data received in slot 6 (DL) and the DL data received in slot 7 (DL). In this case, for example, the DCI for DL data assignment received in slot 6 includes 1 as a DAI, and the DCI for DL data assignment received in slot 7 includes 2 as a DAI. As a result, the terminal 20A can determine whether the DL data corresponding to the HARQ-ACK to be transmitted in the slot 9 has been received. For DAI, there are Option D and Option E described below.

In Option D) In Option D, the SL scheduling DCI transmitted from base station 10 to the terminal 20A does not include DAI, and the DAI included in the DL scheduling DCI is not associated with HARQ-ACK for SL data.

In this case, as for the terminal 20B that receives SL data on PSSCH, for example, the terminal 20A may include DAI for SL data in the SCI transmitted on PSCCH, and the terminal 20B may obtain the DAI from the SCI and utilize the DAI.

Option E) In Option E, DAI is included in the SL scheduling DCI transmitted from the base station 10 to the terminal 20A. The DAI is included in the SCI and transmitted from the terminal 20A to the terminal 20B through PSCCH, and the terminal 20B performs SL HARQ-ACK transmission using the DAI. The terminal 20A utilizes the DAI included in the DL scheduling DCI for the transmission of HARQ-ACK for the DL data.

<PUCCH Resource>

For a PUCCH resource, there are Options F-H, as described below.

Option F) In Option F, at the terminal 20A, a PUCCH resource for transmitting a HARQ-ACK codebook, including HARQ-ACK for DL data and HARQ-ACK for SL data (or including HARQ-ACK for DL data or HARQ-ACK for SL data) is determined by the DCI received at last of a plurality of DL scheduling DCIs having PDSCH-to-HARQ_feedback timing indicator fields specifying the same slot.

That is, for example, when the terminal 20A receives DCI-A, DCI-B, and DCI-C as the DL scheduling DCIs in this order, and when each of the DCI-A, DCI-B, and DCI-C includes a value specifying the same slot as the PDSCH-to-HARQ_feedback timing, the terminal 20A transmits the HARQ-ACK codebook using the PUCCH resource included in the DCI-C in the slot.

Option G) In Option G, at the terminal 20A, a PUCCH resource for transmitting the HARQ-ACK codebook including HARQ-ACK for DL data and a HARQ-ACK for SL data (or HARQ-ACK for DL data or a HARQ-ACK for SL data) is determined by the DCI received at last of a plurality of SL scheduling DCIs having PDSCH/PDCCH-to-HARQ_feedback timer fields specifying the same slot.

That is, for example, when the terminal 20A receives DCI-A, DCI-B, and DCI-C as SL scheduling DCIs in this order, and when each of the DCI-A, DCI-B, and DCI-C includes a value specifying the same slot as PDSCH/PDCH-to-HARQ_feedback timing indicator field, the terminal 20A transmits the HARQ-ACK codebook using the PUCCH resource included in the DCI-C in the slot.

Option H) In Option H, at terminal 20A, a PUCCH resource for transmitting the HARQ-ACK codebook including HARQ-ACK for DL data and HARQ-ACK for SL data (or including HARQ-ACK for DL data or HARQ-ACK for SL data) is determined by the DCI received at last of one or more SL scheduling DCIs and one or more DL scheduling DCIs having PDSCH/PDCCH-to-HARQ_feedback timing indicator fields specifying the same slot.

That is, for example, when the terminal 20A receives DCI-A and DCI-B as the SL scheduling DCIs in this order, then the DCI-C is received as the DL scheduling DCI, and each of the DCI-A, DCI-B, and DCI-C includes a value specifying the same slot as the PDSCH/PDCH-to-HARQ_feedback timing indicator field, the terminal 20A transmits the HARQ-ACK codebook in the slot using the PUCCH resource included in the DCI-C.

Note that, when a PUCCH resource and a PUSCH resource collide each other (at least when they are assigned to the same time resource), the terminal 20A may send the HARQ-ACK codebook through the PUSCH resource without using the PUCCH resource.

### OTHER EXAMPLE

In the above-described example, the DCI transmitted from the base station 10 to the terminal 20A includes information on a PSFCH resource to be used by the terminal 20B to transmit the HARQ-ACK, and the SCI transmitted from the terminal 20A includes information on the PSFCH resource.

Alternatively, the information on the PSFCH resource need not be included in the DL scheduling DCI and the SL scheduling DCI transmitted from the base station 10 to the terminal 20, and the information on the PSFCH resource need not be included in the SCI transmitted from the terminal 20A.

In this case, for example, the terminal 20B that receives the SCI corresponding to the SL data autonomously selects the PSFCH resource and transmits the HARQ-ACK for the SL data to the terminal 20A using the selected resource.

Furthermore, the terminal 20A may include the PSFCH resource indicator (abbreviated as PRI) in the SCI to be transmitted to the terminal 20B, and the value of the PRI may indicate whether a PSFCH resource is specified.

As an example, when PRI=000, the terminal 20B determines that no PSFCH resource is specified and autonomously selects a resource. For example, if the PRI is greater than 000 (e.g., 010), the terminal 20B selects the corresponding PSFCH resource and uses it to transmit the HARQ-ACK for the SL data.

### Second Embodiment

In the second embodiment, the terminal 20B that receives the SL data through PSSCH in the sidelink transmission mode 1 illustrated in FIG. 2 transmits the HARQ-ACK through PSFCH to the terminal 20A that transmits the data. Subsequently, the terminal 20A transmits HARQ-ACK including the HARQ-ACK and HARQ-ACK for the PDSCH reception to the base station 10.

<Configuration Example of the Second Embodiment>

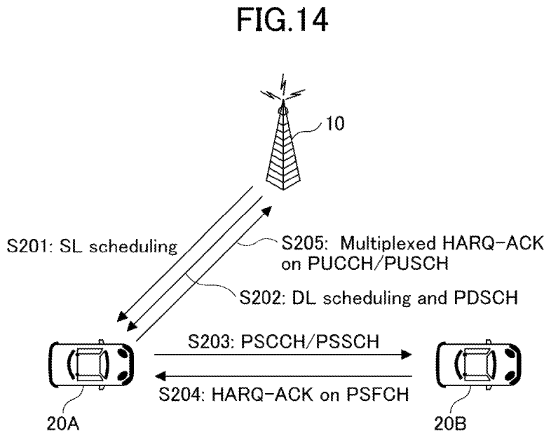

FIG. 14 is a diagram illustrating a configuration (and an operation) of a radio communication system according to the second embodiment.

In S201, the base station 10 performs SL scheduling by sending DCI to the terminal 20A through PDCCH. In S202, the base station 10 transmits DCI for DL scheduling to the terminal 20A by PDDCH. The terminal 20A that receives the DL scheduling DCI receives the DL data through PDSCH using the resource specified in the DL scheduling DCI. The order of execution of S201 and S202 may be reversed, or S202 may be executed later than S203 or S204.

In S203, the terminal 20A transmits the SCI through PSCCH using the resource specified in the SL scheduling DCI and transmits the SL data through PSSCH. Note that, in SL scheduling DCI, only the PSSCH resource may be specified. In this case, for example, the terminal 20A may transmit the SCI (PSCCH) using a frequency resource adjacent to the PSSCH frequency resource with the same time resource as the PSSCH time resource.

The terminal 20B receives the SCI (PSCCH) and the SL data (PSSCH) transmitted from the terminal 20A. The SCI received through the PSCCH may include information on the PSFCH resource for the terminal 20B to send HARQ-ACK for receipt of the data.

The information on the resource may be included in the DL scheduling DCI or SL scheduling DCI transmitted from the base station 10 in S201 and S202, and the terminal 20A may obtain the information on the resource from the DL scheduling DCI or the SL scheduling DCI and include it in the SCI. Alternatively, the DCI transmitted from the base station 10 does not include the information on the resource, and the terminal 20A may autonomously include the information on the resource in the SCI and transmit the information on the resource.

In S204, the terminal 20B transmits the HARQ-ACK for the received data to the terminal 20A using the PSFCH resource specified in the received SCI.

In S205, the terminal 20A transmits the HARQ-ACK using the PUCCH resource specified by the DL scheduling DCI (or the SL scheduling DCI) at the timing (e.g., timing in units of slots) specified by the DL scheduling DCI (or the SL scheduling DCI), for example, and the base station 10 receives the HARQ-ACK. The HARQ-ACK codebook may include HARQ-ACK for SL data received from the terminal 20B and HARQ-ACK for DL data. However, HARQ-ACK for DL data is not included if DL data is not assigned.

Here, the terminal 20A may use one PUCCH resource to transmit a plurality of HARQ-ACK bits, including HARQ-ACK for SL data. For example, HARQ-ACK corresponding to the DL data may be multiplexed with HARQ-ACK corresponding to the SL data on one HARQ-ACK codebook.

For example, a HARQ-ACK codebook corresponding to DL data may be used to multiplex the HARQ-ACK corresponding to the DL data and HARQ-ACK corresponding to SL data.

For example, a type 1 HARQ-ACK codebook, which is a semi-static HARQ-ACK codebook, may be applied to HARQ-ACK corresponding to DL data and a HARQ-ACK codebook corresponding to SL data. For example, the HARQ-ACK payload size in the type 1 HARQ-ACK codebook may be the payload size of the HARQ-ACK corresponding to the DL data plus the number of PSCCH and PSSCH transmission occasions fed back at the same time. Furthermore, if any PDSCH or PSSCH is not received at the PDSCH transmission occasions and the PSSCH transmission occasions, NACK may be generated and transmitted.

Furthermore, for example, a type 2 HARQ-ACK codebook, which is a dynamic HARQ-ACK codebook, may be applied to HARQ-ACK corresponding to DL data and a HARQ-ACK codebook corresponding to SL data. For example, the HARQ-ACK payload size in the type 2 HARQ-ACK codebook may be notified to the terminal 20A by DAI.

The information notified by DAI may be a counter obtained by adding PDSCH to PSSCH and PSSCH sent from the transmitting UE to the receiving UE, or it may be a total of PDSCH, and PSCCH and PSSCH sent from the transmit UE to the receive UE.

If a detection error on PDCCH is detected by DAI, NACK may be generated and transmitted.

By using the type 1 HARQ-ACK codebook or the type 2 HARQ-ACK codebook described above, the terminal 20A can report HARQ-ACK corresponding to the DL data and HARK-ACK corresponding to the SL data at any timing, and handle the SL as one CC (Component Carrier) of the DL.

As another example, when HARQ-ACK corresponding to DL data and HARQ-ACK corresponding to SL data are multiplexed, a HARQ-ACK codebook for DL data and a HARQ-ACK codebook for SL data may be used, respectively.

For example, the HARQ-ACK codebook for DL data and the HARQ-ACK codebook for SL data, respectively, may be configured by higher layer parameters or predefined by a specification.

For example, for HARQ-ACK codebook for DL data or HARQ-ACK codebook for SL data, for one of the HARQ-ACK codebooks, the other HARQ-ACK codebook may be applied to. That is, the HARQ-ACK codebook for DL data may be configured in the same way as the HARQ-ACK codebook for SL data, and the HARQ-ACK codebook for SL data may be configured in the same way as the HARQ-ACK codebook for DL data.

If a HARQ-ACK codebook for DL Data and a HARQ-ACK codebook for SL Data are used, respectively, and the Type 1 HARQ-ACK codebook, which is a semi-static HARQ-ACK codebook, is applied to the HARQ-ACK codebook for SL Data, the HARQ-ACK Payload size of the Type 1 HARQ-ACK Codebook may correspond to the number of PSCCH and PSSCH transmission occasions fed back at the same timing. NACK may also be generated and transmitted if PSCCH and PSSCH are not received on any of PSCCH or PSSCH transmission occasions.

For example, the order of HARQ-ACK bits in the type 1 HARQ-ACK codebook may be the order of the HARQ-ACK corresponding to the DL data and the HARQ-ACK corresponding to the SL data, or the order of the HARQ-ACK corresponding to the SL data and the HARQ-ACK corresponding to the DL data.

If the Type 1 HARQ-ACK codebook is applied to the HARQ-ACK codebook for SL Data, PUCCH overlaps with PUSCH, and HARQ-ACK bits are multiplexed on PUSCH, the DAI included in the UL grant may indicate in a 2-bit field that each HARQ-ACK for DL Data and HARQ-ACK for SL Data exist. Alternatively, if PUCCH overlaps with PUSCH and HARQ-ACK bits are multiplexed on PUSCH, the DAI included in the UL grant may indicate that any one of HARQ-ACK corresponding to the DL data and HARQ-ACK corresponding to the SL data is present. Alternatively, if PUCCH overlaps with PUSCH and HARQ-ACK bits are multiplexed on PUSCH, the DAI included in the UL grant may indicate that any one of the HARQ-ACK corresponding to the DL data and the HARQ-ACK corresponding to the SL data is at least present.

If the HARQ-ACK codebook for DL data and the HARQ-ACK codebook for SL data are used, respectively, and the Type 2 HARQ-ACK codebook that is a dynamic HARQ-ACK codebook is applied to the HARQ-ACK codebook for SL Data, the HARQ-ACK payload size of the Type 2 HARQ-ACK codebook may be notified by DAI. DAI may be separately counted or managed for the HARQ-ACK codebook for DL data and the HARQ-ACK codebook for SL data.

The information notified by DAI may be a counter obtained by adding PDSCH to PSSCH and PSSCH sent from the transmitting UE to the receiving UE, or it may be the total of the PDSCH, and the PSCCH and PSSCH sent from the transmitting UE to the receiving UE.

If a detection error on PDCCH is detected by DAI, NACK may be generated and transmitted.

If the Type 2 HARQ-ACK codebook is applied to the HARQ-ACK codebook for SL Data, PUCCH overlaps with PUSCH, and HARQ-ACK bits are multiplexed on PUSCH, the DAI included in the UL grant may indicate in a 2-bit field that each HARQ-ACK for DL Data and HARQ-ACK for SL Data exist. Alternatively, if PUCCH overlaps with PUSCH and HARQ-ACK bits are multiplexed on PUSCH, the DAI included in the UL grant may indicate that any one of HARQ-ACK corresponding to the DL data and HARQ-ACK corresponding to the SL data is present. Alternatively, if PUCCH overlaps with PUSCH and HARQ-ACK bits are multiplexed on PUSCH, the DAI included in the UL grant may indicate that any one of the HARQ-ACK corresponding to the DL data and the HARQ-ACK corresponding to the SL data is at least present.

As another example, the terminal 20B may use one PSFCH resource to transmit a plurality of HARQ-ACK bits including HARQ-ACK for SL data to terminal 20A.

If the type 1 HARQ-ACK codebook, which is a semi-static HARQ-ACK codebook, is applied to the HARQ-ACK codebook for SL data, the HARQ-ACK payload size of the type 1 HARQ-ACK codebook may correspond to the number of PSCCH and PSSCH transmission occasions in a single PSFCH period. In addition, if a CA is applied, the HARQ-ACK payload size of the type 1 HARQ-ACK codebook may correspond to the number of PSCCH and PSSCH transmission occasions in a single PSFCH period multiplied by the CC number. NACK may also be generated and transmitted if PSCCH and PSSCH are not received on any of the PSCCH or PSSCH transmission occasions. When the type 1 HARQ-ACK codebook, which is a semi-static HARQ-ACK codebook described above, is applied to the HARQ-ACK codebook for SL data, it is possible to prevent incorrect recognition of the payload size.

In addition, if the Type 2 HARQ-ACK codebook, which is a dynamic HARQ-ACK Codebook, is applied to the HARQ-ACK codebook for SL data, the HARQ-ACK payload size of the Type 2 HARQ-ACK Codebook may be indicated by the Sidelink Assignment Indicator (hereinafter referred to as “SAI”) included in the SCI. The SAI may have the same functionality as the DAI.

The information notified by the SAI may be a counter obtained by adding PSCCH to PSSCH transmitted from the transmitting UE to the receiving UE, or the total of PSCCH and PSSCH transmitted from the transmitting UE to the receiving UE.

If a detection error on PSCCH is detected by SAI, NACK may be generated and transmitted.

If the type 2 HARQ-ACK codebook, which is a semi-static HARQ-ACK codebook described above, is applied to the HARQ-ACK codebook for SL data, the generation of redundant bits can be minimized.

The type of HARQ-ACK codebook that applies to the HARQ-ACK codebook for SL data may be predefined by a specification, pre-configured, configured by RRC signaling, or notified by MAC-CE (Medium Access Control-Control Element), DCI or SCI.

If, in a PSFCH resource, HARQ-ACKs corresponding to multiple SL data items are multiplexed, the PSFCH resource may be associated with and/or notified by the latest received SCI. Furthermore, if HARQ-ACKs corresponding to multiple SL data items are multiplexed in the PSFCH resource, the PSFCH resource may be associated with and/or notified by the SCI received at first. Furthermore, if HARQ-ACKs corresponding to multiple SL data items are multiplexed in the PSFCH resource, the PSFCH resource may be associated with and/or notified by the SCI corresponding to the maximum sub-channel index among the received SCIs. Furthermore, if HARQ-ACKs corresponding to multiple SL data items are multiplexed in the PSFCH resource, the PSFCH resource may be associated with and/or notified by the SCI corresponding to the minimum sub-channel index among the received SCIs. Furthermore, if HARQ-ACKs corresponding to multiple SL data items are multiplexed in the PSFCH resource, the PSFCH resource may be associated with and/or notified by the SCI corresponding to the maximum CC index among the received SCIs. Furthermore, if HARQ-ACKs corresponding to multiple SL data items are multiplexed in the PSFCH resource, the PSFCH resource may be associated with and/or notified by the SCI corresponding to the minimum CC index among the received SCIs. By associating as described above, the PSFCH in which HARQ-ACKs are multiplexed can be shared between the sender and the receiver.

The method of reporting the HARQ-ACK from the terminal 20A to the base station 10 described above and the method of reporting the HARQ-ACK from the terminal 20B to the terminal 20A described above may be used in combination. That is, the method or reporting HARQ from the terminal 20B to the terminal 20A may further be applied to the method of reporting HARQ-ACK from the terminal 20A to the base station 10, or the method of reporting HARQ-ACK from the terminal 20A to the base station 10 may be applied to the method of reporting HARQ-ACK from the terminal 20B to the terminal 20A.

According to the above-described embodiments, the terminal 20 can apply the HARQ-ACK codebook to report HARQ-ACK corresponding to SL data and HARQ-ACK corresponding to DL data to the base station 10 while multiplexing the HARQ-ACK corresponding to the SL data and the HARQ-ACK corresponding to the DL data. Furthermore, the terminal 20 can apply a HARQ-ACK codebook to report HARQ-ACKs corresponding to a plurality of SL data items to the transmitting terminal 20 while multiplexing the HARQ-ACKs corresponding to the plurality of SL data items.

That is, in the terminal-to-terminal direct communication, retransmission control can be appropriately executed.

(Device Configuration)

Next, functional configuration examples of the base station 10 and the terminal 20 that perform the processing and operations described above are described. Each of the base station 10 and the terminal 20 includes functions for implementing the above-described embodiments. However, each of the base station 10 and the terminal 20 may include only some functions in the embodiments.

<Base Station 10>

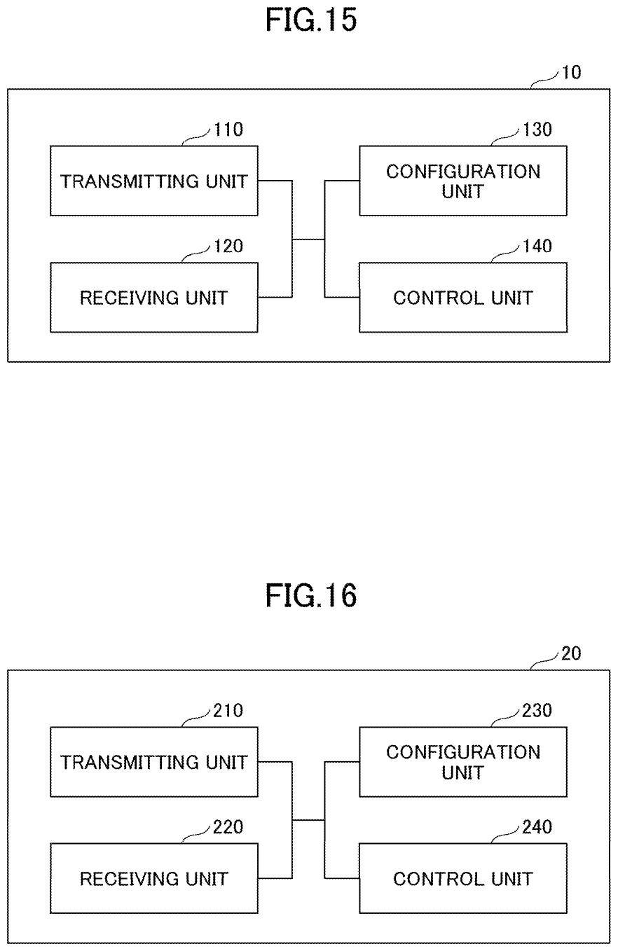

FIG. 15 is a diagram illustrating an example of a functional configuration of a base station 10. As illustrated in FIG. 15, the base station 10 comprises a transmitting unit 110, a receiving unit 120, a configuration unit 130, and a control unit 140. The functional configuration illustrated in FIG. 15 is only an example. Division of the functions and names of functional units may be any division and names, provided that the operations according to the embodiment of the present invention can be performed.

The transmitting unit 110 includes a function that generates a signal to be transmitted to the terminal 20 side and wirelessly transmits the signal. The receiving unit 120 includes a function that receives various signals transmitted from the terminal 20, and obtains, for example, information of a higher layer from the received signal. Furthermore, the transmitting unit 110 has a function for transmitting NR-PSS, NR-SSS, NR-PBCH, DL/UL control signals, DL reference signals, and the like.

The configuration unit 130 stores the preconfigured configuration information and various configuration information to be transmitted to the terminal 20 in the storage device and reads the preconfigured configuration information from the storage device if necessary. The content of the configuration information is, for example, information related to the configuration of D2D communication.

As described in the embodiments, the control unit 140 performs processing related to the configuration for the terminal 20 to perform the D2D communication. The control unit 140 transmits scheduling of D2D communication and DL communication to the terminal 20 through the transmitting unit 110. The control unit 140 receives information related to the HARQ response of the D2D communication and the DL communication from the terminal 20 via the receiving unit 120. A functional unit related to signal transmission in the control unit 140 may be included in the transmitting unit 110, and a functional unit related to signal reception in the control unit 140 may be included in the receiving unit 120.

<Terminal 20>

FIG. 16 is a diagram illustrating an example of a functional configuration of the terminal 20. As illustrated in FIG. 16, the terminal 20 includes a transmitting unit 210, a receiving unit 220, a configuration unit 230, and a control unit 240. The functional configuration illustrated in FIG. 16 is only one example. If the operation according to the embodiments of the present invention can be performed, the functional division and the name of the functional unit may be any division and name.

The transmitting unit 210 creates a transmission signal from the transmission data and wirelessly transmits the transmission signal. The receiving unit 220 receives various signals wirelessly and obtains signals from higher layers from the received signal of the physical layer. The receiving unit 220 has a function to receive NR-PSS, NR-SSS, NR-PBCH, DL/UL/SL control signals or reference signals transmitted from the base station 10. For example, the transmitting unit 210 transmits Physical Sidelink Control Channel (PSCCH), Physical Sidelink Shared Channel (PSSCH), Physical Sidelink Discovery Channel (PSDCH), Physical Sidelink Broadcast Channel (PSBCH), and the like to the other terminal 20 as D2D communication, and the receiving unit 220 receives PSCCH, PSSCCH, PSDCH, PSDCH, and the like from the other terminal 20.

The configuration unit 230 stores various configuration information received from the base station 10 or the terminal 20 by the receiving unit 220 in the storage device and reads it from the storage device as necessary. The configuration unit 230 also stores the preset configuration information. The contents of the configuration information are, for example, information related to the configuration of D2D communication.

The control unit 240 controls D2D communication with another terminal 20 as described in the embodiments. The control unit 240 performs processing related to HARQ of D2D communication and DL communication. The control unit 240 transmits information related to the HARQ response of the D2D communication and the DL communication to the other terminal 20 scheduled from the base station 10. The control unit 240 may schedule D2D communication to the other terminal 20. A functional unit related to signal transmission in the control unit 240 may be included in the transmitting unit 210, and a functional unit related to signal reception in the control unit 240 may be included in the receiving unit 220.

(Hardware Configuration)

Block diagrams (FIG. 15 and FIG. 16) used in the description of the above-described embodiments indicate blocks of functional units. These functional blocks (components) are implemented by any combination of hardware and/or software. In addition, the implementation method of each functional block is not particularly limited. That is, each functional block may be implemented by one device into which a plurality of elements is physically and/or logically coupled or may be implemented by two or more devices that are physically and/or logically separated and that are connected directly and/or indirectly (for example, in a wired and/or wireless manner).

Functions include, but are not limited to, judgment, decision, determination, computation, calculation, processing, derivation, investigation, search, verification, reception, transmission, output, access, resolution, selecting, selection, establishment, comparison, assumption, expectation, deeming, broadcasting, notifying, communicating, forwarding, configuring, reconfiguring, allocating, mapping, and assigning. For example, a functional block (component) that functions to transmit is called a transmitting unit or a transmitter. In either case, as described above, the implementation method is not particularly limited.

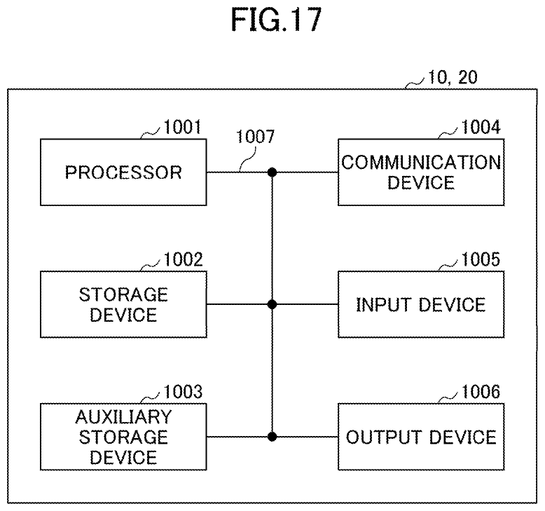

For example, the base station 10, terminal 20, and the like according to an embodiment of the present disclosure may function as a computer for processing the radio communication method of the present disclosure. FIG. 17 is a diagram illustrating an example of the hardware configuration of the base station 10 and the terminal 20 according to an embodiment of the present disclosure. The base station 10 and the terminal 20 described above may be physically configured as a computer device including a processor 1001, a storage device 1002, an auxiliary storage device 1003, a communication device 1004, an input device 1005, an output device 1006, a bus 1007, and the like.

In the following descriptions, the term “apparatus” can be replaced with circuits, devices, units, or the like. The hardware configuration of the base station 10 and the terminal 20 may be configured to include one or more of the devices illustrated in the figure or may be configured without some of the devices.

Each function of the base station 10 and the terminal 20 is implemented by loading predetermined software (program) on hardware, such as the processor 1001, the storage device 1002, and the like, so that the processor 1001 performs computation and controls communication by the communication device 1004, and at least one of reading and writing of data in the storage device 1002 and the auxiliary storage device 1003.

The processor 1001, for example, operates an operating system to control the entire computer. The processor 1001 may be configured with a central processing unit (CPU: Central Processing Unit) including an interface with a peripheral device, a control device, a processing device, a register, or the like. For example, the above-described control unit 140, control unit 240, and the like, may be implemented by the processor 1001.

Additionally, the processor 1001 reads a program (program code), a software module, data, or the like, from at least one of the auxiliary storage device 1003 and the communication device 1004 to the storage device 1002, and executes various processes according to these. As the program, a program is used which causes a computer to execute at least a part of the operations described in the above-described embodiments. For example, the control unit 140 of the base station 10 illustrated in FIG. 6 may be implemented by a control program that is stored in the storage device 1002 and that is operated by the processor 1001. Furthermore, for example, the control unit 240 of the terminal 20 illustrated in FIG. 7 may be implemented by a control program that is stored in the storage device 1002 and that is operated by the processor 1001. While the various processes described above are described as being executed in one processor 1001, they may be executed simultaneously or sequentially by two or more processors 1001. The processor 1001 may be implemented by one or more chips. The program may be transmitted from a network via a telecommunications line.

The storage device 1002 is a computer readable storage medium, and, for example, the storage device 1002 may be formed of at least one of a Read Only Memory (ROM), an Erasable Programmable ROM (EPROM), an Electrically Erasable Programmable ROM (EEPROM), a Random Access Memory (RAM), and the like. The storage device 1002 may be referred to as a register, a cache, a main memory (main storage device), or the like. The storage device 1002 may store a program (program code), a software module, or the like, which can be executed for implementing the communication method according to one embodiment of the present disclosure.

The auxiliary storage device 1003 is a computer readable storage medium and may be formed of, for example, at least one of an optical disk, such as a Compact Disc ROM (CD-ROM), a hard disk drive, a flexible disk, an optical magnetic disk (e.g., a compact disk, a digital versatile disk, a Blu-ray (registered trademark) disk, a smart card, a flash memory (e.g., a card, a stick, a key drive), a floppy (registered trademark) disk, a magnetic strip, and the like. The above-described storage medium may be, for example, a database including at least one of the storage device 1002 and the auxiliary storage device 1003, a server, or any other suitable medium.

The communication device 1004 is hardware (transmitting and receiving device) for performing communication between computers through at least one of a wired network and a wireless network, and is also referred to, for example, as a network device, a network controller, a network card, a communication module, or the like. The communication device 1004 may be configured to include, for example, a high frequency switch, a duplexer, a filter, a frequency synthesizer, or the like, to implement at least one of frequency division duplex (FDD: Frequency Division Duplex) and time division duplex (TDD: Time Division Duplex). For example, a transmitting/receiving antenna, an amplifier unit, a transceiver unit, a transmission line interface, or the like may be implemented by the communication device 1004. The transceiver unit may be implemented so that the transmitting unit and the receiving unit are physically or logically separated.

The input device 1005 is an input device (e.g., a keyboard, a mouse, a microphone, a switch, a button, a sensor) that receives an external input. The output device 1006 is an output device (e.g., a display, speaker, LED lamp) that performs output toward outside. The input device 1005 and the output device 1006 may be configured to be integrated (e.g., a touch panel).

Each device, such as the processor 1001 and the storage device 1002, is also connected by the bus 1007 for communicating information. The bus 1007 may be formed of a single bus or may be formed of different buses between devices.

The base station 10 and the terminal 20 may each include hardware, such as a microprocessor, a digital signal processor (DSP: Digital Signal Processor), an Application Specific Integrated Circuit (ASIC), a Programmable Logic Device (PLD), and a Field Programmable Gate Array (FPGA), which may implement some or all of each functional block. For example, processor 1001 may be implemented using at least one of these hardware components.

### Conclusion of the Embodiments

As described above, according to the embodiments, there is provided a terminal including a receiving unit that receives, from a base station, information for scheduling a first resource used for inter-terminal direct communication, information for scheduling a second resource used for a communication with the base station, and data through the second resource; and a transmitting unit that transmits data to another terminal using the first resource, wherein the receiving unit receives a first response related to retransmission control corresponding to the transmitted data from the another terminal, wherein the terminal further includes a control unit that determines a third response related to retransmission control based on the first response and a second response related to retransmission control corresponding to the data through the second resource, and wherein the transmitting unit transmits the third response to the base station.

According to the above-described configuration, the terminal 20 can report, to the base station 10, the HARQ-ACK corresponding to the SL data and the HARQ-ACK corresponding to the DL data while multiplexing the HARQ-ACK corresponding to the SL data and the HARQ-ACK corresponding to the DL data by applying the HARQ codebook. Namely, in the inter-terminal direct communication, the retransmission control can be appropriately executed.

A codebook defining a retransmission response applied to the third response and a codebook defining a retransmission response applied to the second response may be identical. According to this configuration, the terminal 20 can report, to the base station 10, the HARQ-ACK corresponding to the SL data and the HARQ-ACK corresponding to the DL data while multiplexing the HARQ-ACK corresponding to the SL data and the HARQ-ACK corresponding to the DL data by applying the HARQ codebook.

In a case where the codebook defining the retransmission response applied to the third response is semi-static, a payload size of the codebook defining the retransmission response applied to the third response may be determined based on the first resource and the second resource. According to this configuration, the terminal 20 can report, to the base station 10, the HARQ-ACK corresponding to the SL data and the HARQ-ACK corresponding to the DL data while multiplexing the HARQ-ACK corresponding to the SL data and the HARQ-ACK corresponding to the DL data by applying the HARQ codebook.

In a case where the codebook defining the retransmission response applied to the third response is dynamic, a payload size of the codebook defining the retransmission response applied to the third response may be determined based on a field included in the information for scheduling the first resource or the information for scheduling a second resource. According to this configuration, the terminal 20 can report, to the base station 10, the HARQ-ACK corresponding to the SL data and the HARQ-ACK corresponding to the DL data while multiplexing the HARQ-ACK corresponding to the SL data and the HARQ-ACK corresponding to the DL data by applying the HARQ codebook.

A codebook defining a retransmission response applied to the first response may differ from a codebook defining a retransmission response applied to the second response. According to this configuration, the terminal 20 can report, to the base station 10, the HARQ-ACK corresponding to the SL data and the HARQ-ACK corresponding to the DL data while multiplexing the HARQ-ACK corresponding to the SL data and the HARQ-ACK corresponding to the DL data by applying the HARQ codebook.

Furthermore, according to the embodiments, there is provided a communication method executed by a terminal, the method including a receiving procedure of receiving, from a base station, information for scheduling a first resource used for inter-terminal direct communication, information for scheduling a second resource used for a communication with the base station, and data through the second resource; and a transmitting procedure of transmitting data to another terminal using the first resource, wherein the receiving procedure includes receiving a first response related to retransmission control corresponding to the transmitted data from the another terminal, wherein the method further includes a control procedure of determining a third response related to retransmission control based on the first response and a second response related to retransmission control corresponding to the data through the second resource, and wherein the transmitting procedure includes transmitting the third response to the base station.

According to the above-described configuration, the terminal 20 can report, to the base station 10, the HARQ-ACK corresponding to the SL data and the HARQ-ACK corresponding to the DL data while multiplexing the HARQ-ACK corresponding to the SL data and the HARQ-ACK corresponding to the DL data by applying the HARQ codebook. Namely, in the inter-terminal direct communication, the retransmission control can be appropriately executed.

### Supplemental Embodiments

While the embodiments of the present invention are described above, the disclosed invention is not limited to the embodiments, and those skilled in the art will appreciate various alterations, modifications, alternatives, substitutions, or the like. Descriptions are provided using specific numerical examples to facilitate understanding of the invention, but, unless as otherwise specified, these values are merely examples and any suitable value may be used. Classification of the items in the above descriptions is not essential to the present invention, and the items described in two or more items may be used in combination as needed, or the items described in one item may be applied (as long as there is no contradiction) to the items described in another item. The boundaries of functional units or processing units in the functional block diagram do not necessarily correspond to the boundaries of physical components. An operation by a plurality of functional units may be physically performed by one component or an operation by one functional unit may be physically executed by a plurality of components. For the processing procedures described in the embodiment, the order of processing may be changed as long as there is no inconsistency. For the convenience of the description of the process, the terminal 20 and the base station 10 are described using functional block diagrams, but such devices may be implemented in hardware, software, or a combination thereof. Software operated by a processor included in the terminal 20 in accordance with embodiments of the present invention and software operated by a processor included in the base station 10 in accordance with embodiments of the present invention may be stored in a random access memory (RAM), a flash memory (RAM), a read-only memory (ROM), an EPROM, an EEPROM, a register, a hard disk (HDD), a removable disk, a CD-ROM, a database, a server, or any other suitable storage medium, respectively.

Notification of information is not limited to the aspects/embodiments described in the disclosure, and notification of information may be made by another method. For example, notification of information may be implemented by physical layer signaling (e.g., Downlink Control Information (DCI), Uplink Control Information (UPI), higher layer signaling (e.g., Radio Resource Control (RRC) signaling, Medium Access Control (MAC) signaling, broadcast information (Master Information Block (MIB), System Information Block (SIB))), or other signals or combinations thereof. RRC signaling may be referred to as an RRC message, for example, which may be an RRC connection setup message, an RRC connection reconfiguration message, or the like.

The aspects/embodiments described in this disclosure may be applied to a system using at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), any other appropriate system, and a next generation system extended based on theses. Additionally, a plurality of systems may be combined (e.g., a combination of at least one of LTE and LTE-A and 5G) to be applied.

The processing procedures, sequences, flow charts, or the like of each aspect/embodiment described in this disclosure may be reordered, provided that there is no contradiction. For example, the methods described in this disclosure present elements of various steps in an exemplary order and are not limited to the particular order presented.

The particular operation described in this specification to be performed by base station 10 may be performed by an upper node in some cases. It is apparent that in a network consisting of one or more network nodes having base stations 10, various operations performed for communicating with terminal may be performed by at least one of the base stations 10 and network nodes other than the base stations 10 (e.g., MME or S-GW can be considered, however, the network node is not limited to these). The case is exemplified above in which there is one network node other than the base station 10. However, the network node other than the base station 10 may be a combination of multiple other network nodes (e.g., MME and S-GW).

The information or signals described in this disclosure can be output from a higher layer (or lower layer) to a lower layer (or higher layer). It may be input and output through multiple network nodes.

Input and output information may be stored in a specific location (e.g., memory) or managed using management tables. Input and output information may be overwritten, updated, or added. Output information may be deleted. The input information may be transmitted to another device.

The determination in the disclosure may be made by a value (0 or 1) represented by 1 bit, by a true or false value (Boolean: true or false), or by comparison of numerical values (e.g., a comparison with a predefined value).

Software should be broadly interpreted to mean, regardless of whether referred to as software, firmware, middleware, microcode, hardware description language, or any other name, instructions, sets of instructions, code, code segments, program code, programs, subprograms, software modules, applications, software applications, software packages, routines, subroutines, objects, executable files, executable threads, procedures, functions, or the like.

Software, instructions, information, or the like may also be transmitted and received via a transmission medium. For example, when software is transmitted from a website, server, or other remote source using at least one of wireline technology (such as coaxial cable, fiber optic cable, twisted pair, digital subscriber line) and wireless technology (infrared, microwave, or the like), at least one of these wireline technology and wireless technology is included within the definition of a transmission medium.

The information, signals, or the like described in this disclosure may be represented using any of a variety of different techniques. For example, data, instructions, commands, information, signals, bits, symbols, chips, or the like which may be referred to throughout the above description may be represented by voltages, currents, electromagnetic waves, magnetic fields or magnetic particles, optical fields or photons, or any combination thereof.

The terms described in this disclosure and those necessary for understanding this disclosure may be replaced by terms having the same or similar meanings. For example, at least one of the channels and the symbols may be a signal (signaling). The signal may also be a message. The component carrier may also be referred to as a carrier frequency, cell, frequency carrier, or the like.

As used in this disclosure, the terms “system” and “network” are used interchangeably.

The information, parameters, or the like described in the present disclosure may also be expressed using absolute values, relative values from predetermined values, or they may be expressed using corresponding separate information. For example, radio resources may be those indicated by an index.

The name used for the parameters described above are not restrictive in any respect. In addition, the mathematical equations using these parameters may differ from those explicitly disclosed in this disclosure. Since the various channels (e.g., PUCCH, PDCCH) and information elements can be identified by any suitable name, the various names assigned to these various channels and information elements are not in any way limiting.

In this disclosure, the terms “Base Station,” “Radio Base Station,” “Fixed Station,” “NodeB,” “eNodeB(eNB),” “gNodeB (gNB),” “Access Point,” “Transmission Point,” “Reception Point,” “Transmission/Reception Point,” “Cell,” “Sector,” “Cell Group,” “Carrier,” “Component Carrier,” or the like may be used interchangeably. The base stations may be referred to in terms such as macro-cell, small-cell, femto-cell, pico-cell, or the like.

The base station can accommodate one or more (e.g., three) cells. Where the base station accommodates a plurality of cells, the entire coverage area of the base station can be divided into a plurality of smaller areas, each smaller area can also provide communication services by means of a base station subsystem (e.g., an indoor small base station (RRH) or a remote Radio Head). The term “cell” or “sector” refers to a portion or all of the coverage area of at least one of the base station and base station subsystem that provides communication services at the coverage.

In this disclosure, terms such as “mobile station (MS: Mobile Station)”, “user terminal”, “user equipment (UE: User Equipment)”, “terminal”, or the like may be used interchangeably.

The mobile station may be referred to by one of ordinary skill in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

At least one of a base station and a mobile station may be referred to as a transmitter, receiver, communication device, or the like. At least one of a base station and a mobile station may be a device installed in a mobile body, a mobile body itself, or the like. The mobile body may be a vehicle (e.g., a car, an airplane), an unmanned mobile (e.g., a drone, an automated vehicle), or a robot (manned or unmanned). At least one of a base station and a mobile station includes a device that does not necessarily move during communication operations. For example, at least one of a base station and a mobile station may be an Internet of Things (IoT) device such as a sensor.

In addition, the base station in the present disclosure may be read by the user terminal. For example, various aspects/embodiments of the present disclosure may be applied to a configuration in which communication between the base stations and the user terminal is replaced with communication between multiple user terminals 20 (e.g., may be referred to as Device-to-Device (D2D), Vehicle-to-Everything (V2X)). In this case, a configuration may be such that the above-described function of the base station 10 is included in the user terminal 20. The terms “up” and “down” may also be replaced with the terms corresponding to terminal-to-terminal communication (e.g., “side”). For example, an uplink channel, a downlink channel, or the like may be replaced with a sidelink channel.

Similarly, the user terminal in the present disclosure may be replaced with the base station. In this case, a configuration may be such that the above-described function of the user terminal may be included in the base station.

The terms “determine (determining)” and “decide (determining)” used in this disclosure may include various types of operations. For example, “determining” and “deciding” may include deeming that a result of judging, calculating, computing, processing, deriving, investigating, looking up (e.g., search in a table, a database, or another data structure), or ascertaining is determined or decided. Furthermore, “determining” and “deciding” may include, for example, deeming that a result of receiving (e.g., reception of information), transmitting (e.g., transmission of information), input, output, or accessing (e.g., accessing data in memory) is determined or decided. Furthermore, “determining” and “deciding” may include deeming that a result of resolving, selecting, choosing, establishing, or comparing is determined or decided. Namely, “determining” and “deciding” may include deeming that some operation is determined or decided. “Determine (decision)” may be replaced with “assuming,” “expected,” “considering,” or the like.

The term “connected” or “coupled” or any variation thereof means any direct or indirect connection or connection between two or more elements and may include the presence of one or more intermediate elements between two elements “connected” or “coupled” with each other. The coupling or connection between the elements may be physical, logical, or a combination of these. For example, “connection” may be replaced with “access.” As used in the present disclosure, the two elements may be considered as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS (Reference Signal) or may be referred to as a pilot, depending on the standards applied.

As used in this disclosure, the expression “based on” does not mean “based on only” unless otherwise specified. In other words, the expression “based on” means both “based on only” and “at least based on.”

Any reference to elements using names, such as “first” and “second,” as used in this disclosure does not generally limit the amount or order of those elements. These names can be used in this specification as a convenient way to distinguish between two or more elements. Accordingly, the reference to the first and second elements does not imply that only two elements can be adopted, or that the first element must precede the second element in some way.

The “means” in the configuration of each of the above-described devices may be replaced with “part,” “circuit,” “device,” or the like.

As long as “include,” “including,” and variations thereof are used in this disclosure, the terms are intended to be inclusive in a manner similar to the term “comprising.” Furthermore, the term “or” used in the disclosure is intended not to be an exclusive OR.

A radio frame may be formed of one or more frames in the time domain. In the time domain, each of the one or more frames may be referred to as a subframe. A subframe may further be formed of one or more slots in the time domain. A subframe may be a fixed time length (e.g., 1 ms) that does not depend on numerology.

The numerology may be a communication parameter to be applied to at least one of transmission or reception of a signal or a channel. The numerology may represent, for example, at least one of a subcarrier spacing (SCS: SubCarrier Spacing), a bandwidth, a symbol length, a cyclic prefix length, a transmission time interval (TTI: Transmission Time Interval), a symbol number per TTI, a radio frame configuration, a specific filtering process performed by a transceiver in a frequency domain, a specific windowing process performed by a transceiver in a time domain, or the like.

A slot may be formed of, in a time domain, one or more symbols (Orthogonal Frequency Division Multiplexing (OFDM) symbols, Single Carrier Frequency Division Multiple Access (SC-FDMA) symbols). A slot may be a unit of time based on the numerology.

A slot may include a plurality of mini-slots. In a time domain, each mini-slot may be formed of one or more symbols. A mini-slot may also be referred to as a sub-slot. A mini-slot may be formed of fewer symbols than those of a slot. The PDSCH (or PUSCH) transmitted in a unit of time that is greater than a mini-slot may be referred to as PDSCH (or PUSCH) mapping type A. The PDSCH (or PUSCH) transmitted using a mini-slot may be referred to as PDSCH (or PUSCH) mapping type B.

Each of the radio frame, subframe, slot, mini-slot, and symbol represents a time unit for transmitting a signal. The radio frame, subframe, slot, mini-slot, and symbol may be called by respective different names.

For example, one subframe may be referred to as a transmission time interval (TTI: Transmission Time Interval), a plurality of consecutive subframes may be referred to as TTI, or one slot or one mini-slot may be referred to as TTI. Namely, at least one of a subframe and TTI may be a subframe (1 ms) in the existing LTE, may be a time interval shorter than 1 ms (e.g., 1 to 13 symbols), or a time interval longer than 1 ms. Note that the unit representing the TTI may be referred to as a slot, a mini-slot, or the like, instead of a subframe.

Here, the TTI refers to, for example, the minimum time unit of scheduling in radio communication. For example, in the LTE system, the base station performs scheduling for allocating radio resources (such as a frequency bandwidth, or transmission power that can be used in each terminal 20) in units of TTIs to each terminal 20. Note that the definition of the TTI is not limited to this.

The TTI may be a transmission time unit, such as a channel coded data packet (transport block), a code block, and a codeword, or may be a processing unit for scheduling, link adaptation, or the like. Note that, when a TTI is provided, a time interval (e.g., a symbol number) onto which a transport block, a code block, or a code ward is actually mapped may be shorter than the TTI.

Note that, when one slot or one mini-slot is referred to as a TTI, one or more TTIs (i.e., one or more slots or one or more mini-slots) may be the minimum time unit of scheduling. Additionally, the number of slots (the number of mini-slots) forming the minimum time unit of scheduling may be controlled.

A TTI with a time length of 1 ms may be referred to as an ordinary TTI (TTI in LTE Rel. 8-12), a normal TTI, a long TTI, an ordinary subframe, a normal subframe, a long subframe, a slot, or the like. A TTI that is shorter than a normal TTI may be referred to as a shortened TTI, a short TTI, a partial TTI (partial TTI or fractional TTI), a shortened subframe, a short subframe, a mini-slot, a sub-slot, a slot, or the like.

Note that a long TTI (e.g., a normal TTI, a subframe) may be replaced with a TTI with a time length exceeding 1 ms, and a short TTI (e.g., a shortened TTI) may be replaced with a TTI with a TTI length that is shorter than the TTI length of the long TTI and longer than or equal to 1 ms.

A resource block (RB) is a resource allocation unit in the time domain and the frequency domain, and may include one or more consecutive subcarriers in the frequency domain. A number of subcarriers included in a RB may be the same irrespective of numerology, and may be 12, for example. The number of subcarriers included in a RB may be determined based on numerology.

Additionally, the resource block may include one or more symbols in the time domain, and may have a length of one slot, one mini-slot, one subframe, or one TTI. Each of one TTI and one subframe may be formed of one or more resource blocks.

Note that one or more RBs may be referred to as a physical resource block (PRB: Physical RB), a subcarrier group (SCG: Sub-Carrier Group), a resource element group (REG: Resource Element Group), a PRB pair, a RB pair, or the like.

Additionally, a resource block may be formed of one or more resource elements (RE: Resource Element). For example, 1 RE may be a radio resource area of 1 subcarrier and 1 symbol.

A bandwidth part (BWP: Bandwidth Part) (which may also be referred to as a partial bandwidth) may represent, in a certain carrier, a subset of consecutive common RB (common resource blocks) for a certain numerology. Here, the common RB may be specified by an index of a RB when a common reference point of the carrier is used as a reference. A PRB may be defined in a BWP, and may be numbered in the BWP.

The BWP may include a BWP for UL (UL BWP) and a BWP for DL (DL BWP). For a UE, one or more BWPs may be configured within one carrier.

At least one of the configured BWPs may be active, and the UE is may not assume that a predetermined signal/channel is communicated outside the active BWP. Note that “cell,” “carrier,” or the like in the present disclosure may be replaced with “BWP.”

The structures of the above-described radio frame, subframe, slot, mini-slot, symbol, or the like are merely illustrative. For example, the following configurations can be variously changed: the number of subframes included in the radio frame; the number of slots per subframe or radio frame; the number of mini-slots included in the slot; the number of symbols and RBs included in the slot or mini-slot; the number of subcarriers included in the RB; and the number of symbols, the symbol length, the cyclic prefix (CP: Cyclic Prefix) length, or the like, within the TTI.

In the present disclosure, for example, if an article is added by translation, such as a, an, and the in English, the present disclosure may include that the noun following the article is plural.

In the present disclosure, the term “A and B are different” may imply that “A and B are different from each other.” Note that the term may also imply “each of A and B is different from C.” The terms, such as “separated” or “coupled,” may also be interpreted similarly.

The aspects/embodiments described in this disclosure may be used alone, in combination, or switched with implementation. Notification of predetermined information (e.g. “X” notice) is not limited to a method that is explicitly performed, and may also be made implicitly (e.g. “no notice of the predetermined information”).

Note that, in the disclosure, the HARQ response is an example of a response related to retransmission. The ACK is an example of a positive acknowledgement. The NACK is an example of a negative acknowledgement. The HARQ-ACK codebook is an example of a codebook defining a retransmission response.

While the present disclosure is described in detail above, those skilled in the art will appreciate that the present disclosure is not limited to the embodiments described in the present disclosure. The disclosure may be implemented as modifications and variations without departing from the gist and scope of the disclosure as defined by the claims. Accordingly, the description of the present disclosure is for illustrative purposes only and is not intended to have any restrictive meaning with respect to the present disclosure.

This international patent application is based on and claims priority to Japanese Patent Application No. 2019-155835 filed on Aug. 28, 2019, and the entire content of Japanese Patent Application No. 2019-155835 is incorporated herein by reference.

### LIST OF REFERENCE SYMBOLS

10 base station

110 transmitting unit

120 receiving unit

130 configuration unit

140 control unit

20 terminal

210 transmitting unit

220 receiving unit

230 configuration unit

240 control unit

1001 processor

1002 storage device

1003 auxiliary storage device

1004 communication device

1005 input device

1006 output device

1. A terminal comprising:
a receiving unit that receives, from a base station,
information for scheduling a first resource used for inter-terminal direct communication,
information for scheduling a second resource used for a communication with the base station, and
data through the second resource; and
a transmitting unit that transmits data to another terminal using the first resource,
wherein the receiving unit receives a first response related to retransmission control corresponding to the transmitted data from the another terminal,
wherein the terminal further includes a control unit that determines a third response related to retransmission control based on the first response and a second response related to retransmission control corresponding to the data through the second resource, and
wherein the transmitting unit transmits the third response to the base station.

2. The terminal according to claim 1, wherein a codebook defining a retransmission response applied to the third response and a codebook defining a retransmission response applied to the second response are identical.

3. The terminal according to claim 2, wherein, in a case where the codebook defining the retransmission response applied to the third response is semi-static, a payload size of the codebook defining the retransmission response applied to the third response is determined based on the first resource and the second resource.

4. The terminal according to claim 2, wherein, in a case where the codebook defining the retransmission response applied to the third response is dynamic, a payload size of the codebook defining the retransmission response applied to the third response is determined based on a field included in the information for scheduling the first resource or the information for scheduling a second resource.

5. The terminal according to claim 1, wherein a codebook defining a retransmission response applied to the first response differs from a codebook defining a retransmission response applied to the second response.

6. A communication method executed by a terminal, the method comprising:
a receiving procedure of receiving, from a base station,
information for scheduling a first resource used for inter-terminal direct communication,
information for scheduling a second resource used for a communication with the base station, and
data through the second resource; and
a transmitting procedure of transmitting data to another terminal using the first resource,
wherein the receiving procedure includes receiving a first response related to retransmission control corresponding to the transmitted data from the another terminal,
wherein the method further includes a control procedure of determining a third response related to retransmission control based on the first response and a second response related to retransmission control corresponding to the data through the second resource, and
wherein the transmitting procedure includes transmitting the third response to the base station.
